(19) United States
(12) Patent Application Publication
(10) Pub. No.: US 2017/0330154 A1
(43) Pub. Date: Nov. 16, 2017

(54) COMPUTER-IMPLEMENTED METHOD AND COMPUTER SYSTEM FOR GENERATING AND USING A SUITABILITY SCORE

(71) Applicant: MasterCard International Incorporated, Purchase, NY (US)

(72) Inventor: Vijendra Pratap Singh, Pune (IN)

(21) Appl. No.: 15/490,066

(22) Filed: Apr. 18, 2017

(30) Foreign Application Priority Data
May 10, 2016 (SG) 10201603693R

(51) Int. Cl. G06Q 10/10; G06Q 50/00; G06F 7/02

(52) U.S. Cl. CPC G06Q 10/1053; G06F 7/02; G06Q 50/01

(57) ABSTRACT

An automatic process is proposed in which a computer extracts data relating to an individual from a social media site, and automatically compares the extracted data with a job description to form a numerical suitability index. Since the data is extracted from a social media site, its coverage is not limited to individuals who are part of a database maintained by a recruitment consultant. The numerical suitability indices for a plurality of individuals are used to screen the individuals, to select individuals to participate in further stages of a recruitment process. Thus, an automatic screening of the individuals is possible, saving considerable time. In one example, if a large number of individuals have applied for a job, they can be screened automatically, to produce manageable short-list of candidates.

### CROSS-REFERENCE TO RELATED APPLICATION

This application is a U.S. National Stage filing under 35 U.S.C. §119, based on and claiming benefit of and priority to SG Patent Application No. 10201603693R filed May 10, 2016.

### FIELD OF THE INVENTION

The present invention relates to a computer-implemented method and computer system for generating a suitability score indicating the suitability of an individual for a job (typically an employment position), as well as a computer-implemented method and computer system for employing the suitability score in a candidate screening process.

### BACKGROUND OF THE INVENTION

Many businesses and other organizations invest significant resources in finding suitable individuals to fill roles (“jobs”) within the organizations. These resources may include the time of a HR (human resources) department as well as other staff of the organization, such as prospective supervisors and co-workers of the individuals once the employment position is filled. Furthermore, some organizations outsource some or all of this work to a recruitment company which charges high fees, typically equating to several months' of the salary of the individuals recruited.

The search for suitable individuals may be conducted by placing recruitment advertisements in publications which prospective employees are expected to read. If many individuals see the adverts, and apply for it, a time-consuming process may be required to select one of the individuals.

Alternatively, the search may include “head-hunting” suitable individuals, for example using a database maintained by the head-hunting company. If no database is available, or the database does not contain suitable individuals, the head-hunting process may include searching for suitable individuals, for example by randomly contacting individuals employed in the relevant industry. Once individuals are identified, their background and qualifications are typically examined in more detail, which is again a time-consuming process. Altogether the recruitment process may take a considerable time, and during this time the organization may suffer because the employment position is not filled.

### SUMMARY OF THE INVENTION

The present invention aims to provide new and useful computer-implemented methods and computer systems for generating automatically a suitability score for an individual in relation to a job, and for using the suitability score as part of a recruitment process.

In general terms, the present invention proposes an automatic process in which a computer extracts data relating to an individual from a social media site, and compares the extracted data with a job description to form a numerical suitability index.

Since the data is extracted from a social media site, its coverage is not limited to individuals who are part of a database maintained by an organization or a recruitment consultant. Furthermore, the invention makes it possible to generate a suitability index for each of a large number of individuals with little or no expenditure of human time, and thus reduces the work of a head-hunting operation.

Specifically, in another aspect, the invention proposes automatically generating a numerical suitability index for a plurality of individuals using respective data extracted from social media site(s), and screening the individuals based on the numerical suitability score to identify candidates for whom the numerical suitability score meets a criterion.

The individuals may for example be individuals who have applied for the job, for example by submitting a curriculum vitae. They may be been requested to include their respective user ID (identification code) for at least one social media platform as part of the application. Thus, the invention makes it possible to significantly reduce the work of screening a large number of applications by arranging for the initial screening step to be performed automatically.

Following the screening step, the identified individuals may then be entered into further stages of a recruitment procedure. In the next stage, for example, they may be contacted to obtain further information to assess their suitability for the job and/or their desire for the job. Based on this information, a reduced short-list may be obtained. Finally, an individual is selected from the reduced short-list and appointed to the job.

As used in this application, the term “job” refers to an activity performed by an individual for an organization, such as a commercial company, a charitable organization or a government department. The term “recruitment” refers to identifying an individual to perform the activity, and agreeing with the individual that the individual will carry out the activity. The individual is typically remunerated by the organization for performing the activity, but the term “job” is used here also to include also activities which are performed without monetary remuneration (such as certain internships). Furthermore, the individual once recruited may be a legal employee of the organization, but the term “job” is not limited in this respect, and includes also the possibility that the individual is recruited on a consultancy basis (i.e. without becoming an employee of the organization).

The term “social media website” is used to refer to a website maintained by a server which allow the creation and exchange of user-generated content. Typically, individuals are able to establish respective accounts at a social media website. The individuals populate the accounts with information about themselves. Exemplary social media websites include LinkedIn™, but many social media sites exist, including various jobs boards where individuals supply information about themselves and jobs they would like to obtain.

The term “automatic” is used to mean a process which is carried out substantially without human involvement, save for initiation of the process.

As used in this application, the terms “component,” “module,” “engine,” “system,” “apparatus,” “interface,” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. For instance, the claimed subject matter may be implemented as a computer-readable medium embedded with a computer executable program, which encompasses a computer program accessible from any computer-readable storage device or storage media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ).

### BRIEF DESCRIPTION OF THE DRAWINGS

An embodiment of the invention will now be described, for the sake of example only, with reference to the following drawings, in which:

FIG. 1 is a flowchart of a method which is an embodiment of the invention;

FIG. 2 shows schematically the logical structure of a computer system for performing the invention;

FIG. 3 shows flows of information within the computer system of FIG. 2 during the performance of the method of FIG. 1; and

FIG. 4 shows schematically the technical architecture of the computer system of FIG. 2.

### DETAILED DESCRIPTION OF THE EMBODIMENTS

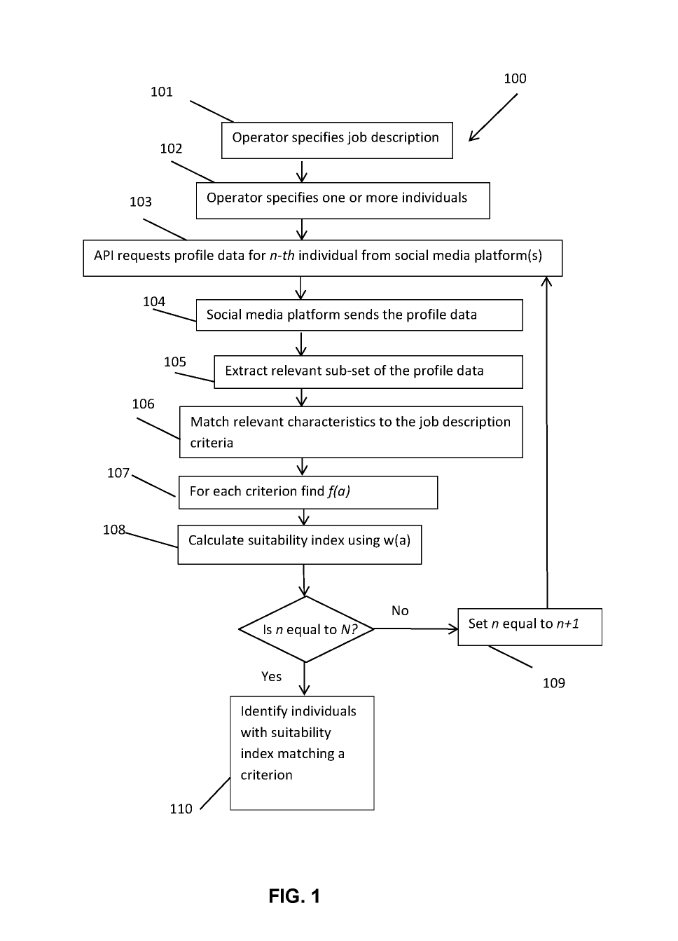

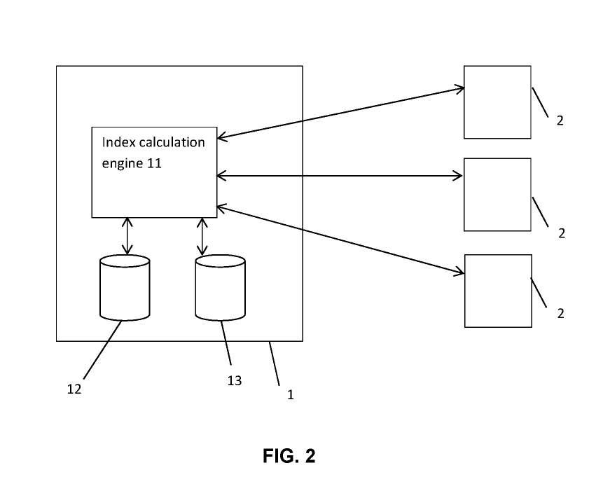

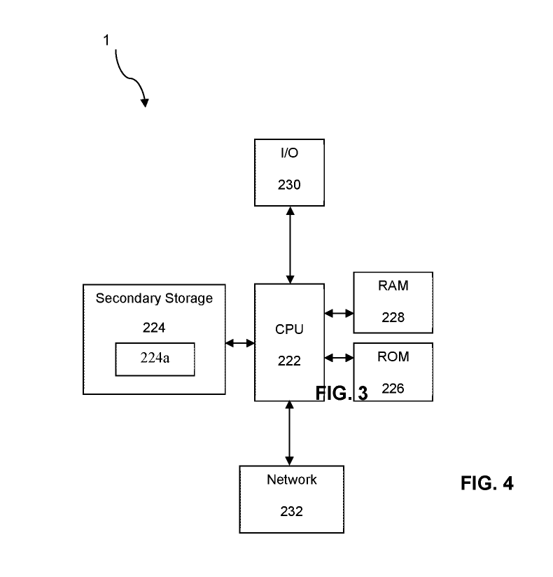

Referring firstly to FIG. 1, a flowchart is shown of a method 100 which is an embodiment of the invention. The method is performed by a computer system 1 having a logical structure as shown in FIG. 2, and a technical architecture as shown in FIG. 4 (described below).

As shown in FIG. 2, the computer system 1 comprises an application programming interface (API) 11 which functions as an index calculation engine. The index calculation engine 11 has access to a job description database 12 and a candidate database 13, and is enabled to generate a user interface (UI) for two-way communication with a user of the server 1, referred to here as an “operator”. This operator may be a recruiter (either one who is part of the organization associated with the job, or an external recruiter).

The index calculation engine 11 is enabled to communicate over a communication network with one or more social media platforms 2, which are external to the computer system 1 (e.g. operated and owned by different individuals). The social media platforms 2 are typically respective computer server systems which support respective social media websites. The social media platforms may include LinkedIn (a social networking site), but may also include job board and other social media sites where information about individuals is posted.

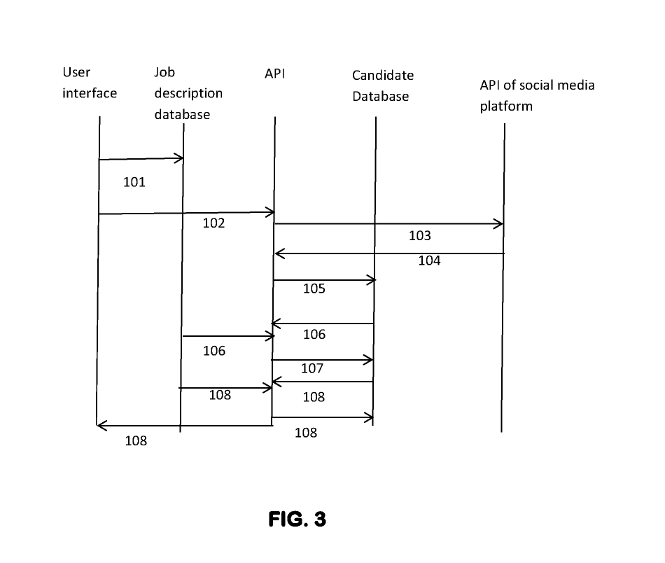

The method 100 is to generate a suitability index in relation to a certain individual. The flow of information is as shown in FIG. 3.

The first step 101 of the method 100 is for the operator to input a job description. This can be done in various formats, depending upon how the job description is to be used later in the method. For example, the operator can key in all the relevant job description functions. Optionally, the operator can add a numerical desired level of match/proficiency, which is explained below.

In one example the job description may be in the following format:

TABLE 1

| | Corresponding requirement |
|---|---|
| Criterion type | of job description |
| Skills | JAVA, SELENIUM, SPRING |
| Education | Good college |
| Patents | More than one patent |
| Honours/Awards | More than 5 honours |
| Recommendation | More than 5 recommendations |
| Certificates | More than two relevant certifications |
| Courses | Attended more than two courses |
| Publications | Published more than two articles of papers |

These criteria may be denoted by respective values of an integer variable a, and the set of criteria is denoted by A. For each of the criteria a the operator may specify a corresponding weight w(a) indicating the importance of the criterion. Conveniently, the values w(a) may sum up to 100%. All the information specified by the operator in step 101 is stored in the job description database 12.

The second step 102 of the method 101 is for the operator to input data specifying a set of N individuals for whom a suitability index is to be calculated. The individuals may be labelled using an integer index n=1, . . . N. One way of doing this would be for the user to specify data identifying a particular individual, for example by specifying a userID of an individual on a certain one of the social media platform 2. The userID is a label for the individual's account on the social media site supported by the social medial platform 2. The operator could do this for a list of individuals for each of whom the respective userID had been obtained in advance. For example, the operator may have placed a job advert stating that job applications should include a userID on a social media site; then the operator may extract the userIDs from any job applications received.

Alternatively, the operator could specify one or more of the social media platforms 2, and the index calculation would calculate a respective suitability index for each of the individuals who have accounts on the specified social media platform(s) 2.

Initially n−1. In step 103, the index calculation engine 11 requests data relating to the n-th individual specified in step 102 from respective APIs running on the social media platform(s) 2, for example by supplying the userID received in step 102 to the corresponding social media platform.

In step 104, the social medial platforms return to the index calculation engine 11 the profile data corresponding to the userID. For example, the LinkedIn™ site provides a file of profile data for each of its members which comprises the following items:

TABLE 2

| Field name | Description |
|---|---|
| Last modified timestamp | A timestamp indicating when the |
| | individual's profile was last edited. |
| Proposal-commends | A short-form text area describing how the |
| | individual approaches job proposals |
| Associations | A short-form text areas listing various |
| | associations the individual is a part of. |
| Interests | A short-form text area describing the |
| | individual's interests |
| Publications | An object representing the various |
| | publications associated with the individual |
| Patents | An object representing any patents |
| | associated with the individual |
| Languages | An object representing languages that the |
| | individual knows |
| Skills | An object representing skills that the |
| | individual holds |
| Qualifications | An object representing any certifications |
| | that the individual holds |
| Education | An object representing the individual's |
| | educational background |
| Courses | An object representing courses the |
| | individual has taken |
| Volunteer | An object representing the individual's |
| | volunteer experiences |
| Three-current-positions | A collection of current positions that the |
| | individual holds, capped at three |
| Three-past-positions | A collection of the most recent positions |
| | that the individual has held, capped at three |
| Num-recommendations | The number of recommendations that the |
| | individual has |
| Recommendations-received | An object representing the |
| | recommendations that the member has |
| | received. |
| Following | A collection of people, companies and |
| | industries that the individual is following |
| Job-bookmarks | A collection of jobs that the individual is |
| | following |
| Suggestions | A collection of people, companies and |
| | industries suggested for the individual to |
| | follow |
| Date-of-birth | The individual's date of birth. The |
| | individual may not supply the year as part |
| | of the date. |
| Member-url-resources | An object representing any URLs (uniform |
| | resource locators) the individual has |
| | shorted on their profile |
| Related-profile-views | An object listing related member profiles |
| | that were viewed before or after the |
| | member's profile |
| Honours-awards | An object representing the various honours |
| | and awards the member has received. |

In step 105, the index calculation engine 11 extracts relevant characteristics from the profile data (i.e. forms a sub-set of the profile data). For example, for a certain individual with an account ID XYZ, the index calculation engine 11 may use the profile data to obtain the following relevant characteristics. The data is stored in the candidate database 13.

TABLE 3

| | |
|---|---|
| Account ID | XYZ |
| Certifications | JAVA Sun Certified, PMP, |
| | CSM and CISSP, . . . |
| Development skills | JAVA, SPRING |
| Testing Skills | SELENIUM |
| Management skills | Management skills: AGILE, |
| | SDLC, Project management, |
| | Program Management, |
| | Portfolio management |
| Total years of experience | 6 |
| College | Harvard University |
| Open Source Certification | Contributed to GIT |
| Publications | 5 Technical papers |
| Awards | Best developer |
| Recommendations | 3 recommendations |

In step 106, the index calculation engine 11 uses the data in the job description database 12 and the candidate database 13, to match the relevant characteristics of the individual to each of the criteria of the job description. For example, for the individual with an account ID XYZ, the index calculation engine 11 may determine that the individual has the following characteristics:

TABLE 4

| | |
|---|---|
| Criterion type | Individual XYZ's characteristics |
| Skills | Development skills: JAVA, SPRING |
| | Testing skills: SELENIUM |
| | Management skills: AGILE, SDLC, Project |
| | management, Program |
| | management, Portfolio |
| | management |
| Education | Harvard University |
| Patents | None |
| Honours/Awards | Best developer |
| Recommendation | 3 recommendations |
| Certificates | JAVA Sun Certified, PMP, CSM and CISSP, . . . |
| Courses | 2 courses |
| Publications | 5 Technical papers |

In step 107, the index calculation engine 11 calculates for each of the criteria a a respective value f(a) indicating the degree to which the respective element of the profile data obtained in step 105 matches the job criterion defined in step 101. The result is stored in the candidate database 13. The value f(a) may be specified in terms of a percentage. For example, if the job description specifies that the skills requires are “Core Java”, “Rest” and “Spring”, and if an individual has only one of these skills, the score for f(skills) would be 33%.

Note that for certain criteria, the recruiter may have to supply (e.g. in step 101) data specify the extent to which a certain characteristic of the individual matches the job description. For example, in the case of the criterion “education”, the recruiter may have to specify the extent to which each of a number of universities meets this criterion. Harvard University might be given a value 50% here, if the recruiter regards it as not being tier 1 for this job. More generally, in step 101 the operator may define (or import) multiple tiers of educational institutions, each being associated with a respective set of educational institutions, and specify a respective percentage for each of the tiers, such that if an individual has attended an educational institution in one of the tiers, then the individual's value of f(a) for the criterion “education” is the specified percentage for the tier.

In step 108, the index calculation engine 11 fetches the values w(a) and f(a) from the databases 12, 13 respectively, to calculate a suitability index for the individual, for example using the expression:

$$Suitability index = \frac{{\sum }_{a ∈ A}^{ } f ( a ) w ( a )}{{\sum }_{a ∈ A}^{ } w ( a )} \qquad ( 1 )$$

The suitability index is then written to the candidate database 13, and may be returned to the user interface. For example, doing this for the individual with userID XYZ the following results are obtained:

| | f(a) (i.e. | | Weighted | |
|---|---|---|---|---|
| | percentage | | Score | Suitability |
| Criterion type | match) | w(a) | (f(a)w(a)) | index |
| Skills | 100 | 20% | 20 | 59.5 |
| Education | 50 | 10% | 5 | |
| Patents | 0 | 15% | 0 | |
| Honours/Awards | 20 | 15% | 3 | |
| Recommendation | 50 | 5% | 2.5 | |
| Certificates | 100 | 15% | 15 | |
| Courses | 40 | 10% | 4 | |
| Publications | 100 | 10% | 10 | |

If only a single individual was specified in step 102 (i.e. N=1), then the method 100 may terminate here. Alternatively, if a plurality of individuals were specified then in step 102 (i.e. N>1), and if n is less than N, then in step 109 the method 100 may loop back to step 103, increasing the value of n by 1, until a respective suitability index has been calculated for each of the individuals.

In step 110, the method may identify which of the individuals have a suitability index which meets a certain criterion. Thus, step 110 is a screening step based on the suitability index: it results in a shortlist of individuals to consider for the job. The criterion may be that the suitability index is above a threshold. The threshold may be the numerical desired level of match/proficiency specified in step 101. Alternatively, it may be selected such that a desired number of individuals are identified in step 110.

The operator is now able to use the result of the screening step to conduct further investigation of the identified individuals, for example by approaching them to ask for further information about themselves and whether they would be interested in the job. This may be done in an order depending on the suitability index (i.e. contacting first the identified individuals for whom the suitability index is highest).

In one example, if a hundred individuals (“talents”) have applied for a particular job, the operator can use the index calculation engine 11 to calculate a hundred respective suitability indices. The operator may the set a threshold, e.g. 40%, and pick the set of individuals who have scores greater than 40% for more detailed review.

FIG. 4 is a block diagram showing a technical architecture of the computer system 1. The technical architecture includes a processor 222 (which may be referred to as a central processor unit or CPU) that is in communication with memory devices including secondary storage 224 (such as disk drives), read only memory (ROM) 226, random access memory (RAM) 228. The processor 222 may be implemented as one or more CPU chips. The technical architecture may further comprise input/output (I/O) devices 230, and network connectivity devices 232.

The secondary storage 224 is typically comprised of one or more disk drives or tape drives and is used for non-volatile storage of data and as an over-flow data storage device if RAM 228 is not large enough to hold all working data. Secondary storage 224 may be used to store programs which are loaded into RAM 228 when such programs are selected for execution.

In this embodiment, the secondary storage 224 has a processing component 224a comprising non-transitory instructions operative by the processor 222 to perform various operations of the method of the present disclosure. The ROM 226 is used to store instructions and perhaps data which are read during program execution. The secondary storage 224, the RAM 228, and/or the ROM 226 may be referred to in some contexts as computer readable storage media and/or non-transitory computer readable media.

I/O devices 230 may include printers, video monitors, liquid crystal displays (LCDs), plasma displays, touch screen displays, keyboards, keypads, switches, dials, mice, track balls, voice recognizers, card readers, paper tape readers, or other well-known input devices.

The network connectivity devices 232 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards that promote radio communications using protocols such as code division multiple access (CDMA), global system for mobile communications (GSM), long-term evolution (LTE), worldwide interoperability for microwave access (WiMAX), near field communications (NFC), radio frequency identity (RFID), and/or other air interface protocol radio transceiver cards, and other well-known network devices. These network connectivity devices 232 may enable the processor 222 to communicate with the Internet or one or more intranets. With such a network connection, it is contemplated that the processor 222 might receive information from the network, or might output information to the network in the course of performing the above-described method operations. Such information, which is often represented as a sequence of instructions to be executed using processor 222, may be received from and outputted to the network, for example, in the form of a computer data signal embodied in a carrier wave.

The processor 222 executes instructions, codes, computer programs, scripts which it accesses from hard disk, floppy disk, optical disk (these various disk based systems may all be considered secondary storage 224), flash drive, ROM 226, RAM 228, or the network connectivity devices 232. While only one processor 222 is shown, multiple processors may be present. Thus, while instructions may be discussed as executed by a processor, the instructions may be executed simultaneously, serially, or otherwise executed by one or multiple processors.

Although the technical architecture is described with reference to a computer, it should be appreciated that the technical architecture may be formed by two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the technical architecture 220 to provide the functionality of a number of servers that is not directly bound to the number of computers in the technical architecture 220. In an embodiment, the functionality disclosed above may be provided by executing the application and/or applications in a cloud computing environment. Cloud computing may comprise providing computing services via a network connection using dynamically scalable computing resources. A cloud computing environment may be established by an enterprise and/or may be hired on an as-needed basis from a third party provider.

It is understood that by programming and/or loading executable instructions onto the technical architecture, at least one of the CPU 222, the RAM 228, and the ROM 226 are changed, transforming the technical architecture in part into a specific purpose machine or apparatus having the novel functionality taught by the present disclosure. It is fundamental to the electrical engineering and software engineering arts that functionality that can be implemented by loading executable software into a computer can be converted to a hardware implementation by well-known design rules.

Whilst the foregoing description has described exemplary embodiments, it will be understood by those skilled in the art that many variations of the embodiment can be made within the scope and spirit of the present invention.

1. A computer-implemented process for generating a suitability score for an individual in relation to a job described by a job description defined by one or more criteria, the method comprising a computer system:
transmitting, to a social media platform, data identifying the individual;
receiving profile data from the social media platform describing the individual;
extracting, from the profile data, information relevant to the criteria; and
calculating the suitability score as a number indicative of the match between the extracted information and the criteria.

2. A computer-implemented method according to claim 1 in which the suitability score is calculated by:
calculating, for each of the criteria, a respective matching value indicative of the degree of matching of the extracted data to the criterion, and
obtaining the suitability score as a function of the matching values.

3. A computer-implemented method according to claim 2, in which the job description includes a weighting value for each of the criteria, and the suitability score is calculated from the matching values as a weighted sum over the criteria of the matching values weighted by the respective weighting value.

4. A computer-implemented method of screening a plurality of individuals for a job described by a job description defined by one or more criteria, the method comprising a computer system:
performing a method according to any of claim 1, to generate for each individual a respective suitability score, and
selecting from among the individuals a subset of the individuals for whom the respective suitability scores meet a criterion.

5. A computer system for generating a suitability score for an individual in relation to a job, the computer system comprising:
a job description database storing a job description defined by one or more criteria,
an index calculation engine operative to:
transmit to a social media platform data identifying the individual;
receive profile data from the social media platform describing the individual;
extract from the profile data information relevant to the criteria; and
calculate the suitability score as a number indicative of the match between the extracted information and the criteria.

6. A computer system according to claim 5 in which the index calculation engine is configured to calculate the suitability score by:
calculating, for each of the criteria, a respective matching value indicative the degree of matching of the extracted data to the criterion, and
obtaining the suitability score as a function of the matching values.

7. A computer system according to claim 6, in which the job description includes a weighting value for each of the criteria, and the index calculation engine is configured to calculate the suitability score from the matching values as a weighted sum over the criteria of the matching values weighted by the respective weighting value.

8. A computer system according to any of claim 5 in which the index configuration engine is operative to identify individuals for whom the respective suitability scores meet a criterion.
